(19) United States
(12) Patent Application Publication
(10) Pub. No.: US 2019/0080025 A1
(43) Pub. Date: Mar. 14, 2019

(54) MOBILE NAVIGATION DEVICE FOR DIGITAL GAUGE

(71) Applicant: EngView Systems Sofia JSC, Sofia (BG)

(72) Inventors: Vladimir Borislavov Vladimirov, Sofia (BG); Georgi Parvanov Marinov, Sofia (BG)

(21) Appl. No.: 15/702,826

(22) Filed: Sep. 13, 2017

(51) Int. Cl. G06F 17/50; G06F 11/30

(52) U.S. Cl. CPC G06F 17/50; G06F 11/3024; G06F 11/3096

(57) ABSTRACT

A mobile display device is arranged in communication with the digital gauge. A processor of the mobile display device with access to a CAD model and a measurement plan sequentially indicates different dimensions of the CAD model as being active on the display device in accordance with the measurement plan. Measurement data of the test part from the digital gauge is displayed in association with the respective dimensions of the CAD model that are sequentially indicated as being active on the display.

### TECHNICAL FIELD

The invention relates to portable, particularly hand-held, measuring devices and mobile display devices in communication with the measuring devices for assisting in the acquisition of measurements.

### BACKGROUND OF THE INVENTION

Mobile measuring devices, such as hand-held digital gauges can be arranged for taking a variety of measurements of test objects. Such measuring devices are readily capable of recording and displaying instant measuring results as well as communicating the instant measuring results to a programmed computer for relating the instant measurements to particular dimensions of modeled test objects. For example, the programmed computer can access a computer-aided design (CAD) model of a test object, and the instant measuring results from the mobile measuring devices can be compared to toleranced dimensions of the CAD model. Instructions for taking a series of measurements of the test object can also be accessed by the programmed computer and incorporated into an application that relates measurements acquired according to the instructions with the dimensions of the CAD model.

However, better integration between the CAD model and the measurements of the test object would be desirable to assure that the correct measurements are taken by the mobile measuring devices.

### SUMMARY OF THE INVENTION

One or more embodiments provide for integrating a CAD model of a test part with a measurement plan to highlight dimensions of the CAD model intended for measurement on a display of a mobile display device that is linked to a digital gauge. Measurement data subsequently acquired from the digital gauge can be displayed in association with the highlighted dimensions on the display of a mobile display device.

One version of the invention as a mobile CAD navigated measurement device for coordinating the measurement of a plurality of dimensions of a test part with a digital gauge features a mobile display device including a processor, a memory, a communication port, and a display. The mobile display device is arranged to be in communication with the digital gauge through the communications port. The processor is arranged for accessing a CAD model of the test part stored in the memory and for displaying a graphical image of the CAD model on the display. The processor is further arranged (a) for accessing a measurement plan stored in the memory that includes a schedule of a succession of intended measurements of the test part and (b) for sequentially indicating different dimensions of the CAD model as being active on the display in accordance with the measurement plan. The communication port is arranged to separately receive measurement data of the test part from the digital gauge in response to each of the dimensions of the CAD model that is sequentially indicated as active on the display. The processor is yet further arranged to display the separately received measurement data of the test part from the digital gauge in association with the respective dimensions of the CAD model that are sequentially indicated as being active on the display and to record the separately received measurement data of the test part as a measurements of corresponding dimensions of the test part.

Preferably, the processor displays the respective dimensions of the CAD model that are sequentially indicated as being active on the display as highlighted dimension lines. For example, highlighted dimension lines can be distinguished by a change in a least one of color, intensity, or displayed representation of the lines themselves or of their local background. The processor can be further arranged to compare the measurements of corresponding dimensions of the test part to tolerances within the CAD model for accepting or rejecting the test part.

Another version of the invention as a method of coordinating the measurement of a plurality of dimensions of a test part with a digital gauge includes arranging a mobile display device in communication with the digital gauge through the communications port of the mobile display device. Both a CAD model of the test part and a measurement plan for the test part are accessed from a memory of the mobile display device. A graphical image of the CAD model is displayed on a display of the mobile display device. A first dimension of the displayed CAD model is indicated as being active on the display in accordance with the measurement plan, which is arranged to schedule a succession of intended measurements of the test part. First measurement data of the test part is received from the digital gauge through the communication port. The first measurement data of the test part received from the digital gauge is displayed in association with the first dimension of the displayed CAD model that was indicated as being active on the display. The measurement plan is further accessed to determine if another measurement of the test part is scheduled. A second dimension of the displayed CAD model is indicated as being active on the display in accordance with a second measurement of the test part scheduled by the measurement plan. Second measurement data of the test part is received from the digital gauge through the communication port. The second measurement data of the test part received from the digital gauge is displayed in association with the second dimension of the displayed CAD model that was indicated as being active on the display. The first and second measurement data of the test part are recorded as measurements of corresponding first and second dimensions of the test part.

### BRIEF DESCRIPTION OF THE DRAWING FIGURES

FIG. 1 is a diagram showing communications flows between one or more of a number of digital gauges and a mobile display device.

FIG. 2 is a diagram of major components within the mobile display device.

FIG. 3 is a front view of the mobile display device in which a CAD model of a test part is displayed by the mobile display device.

FIG. 4 is a flow diagram of programmed interactions between the mobile display device and the digital gauge under control of a common operator.

FIG. 5 is a similar front view of the mobile display device in which the CAD model of a test part is displayed together with a highlighted dimension of the CAD model.

FIG. 6 is a diagram of the operator controlling the programmed interactions of the mobile display device and the digital gauge for measuring a test part.

### DETAILED DESCRIPTION OF THE INVENTION

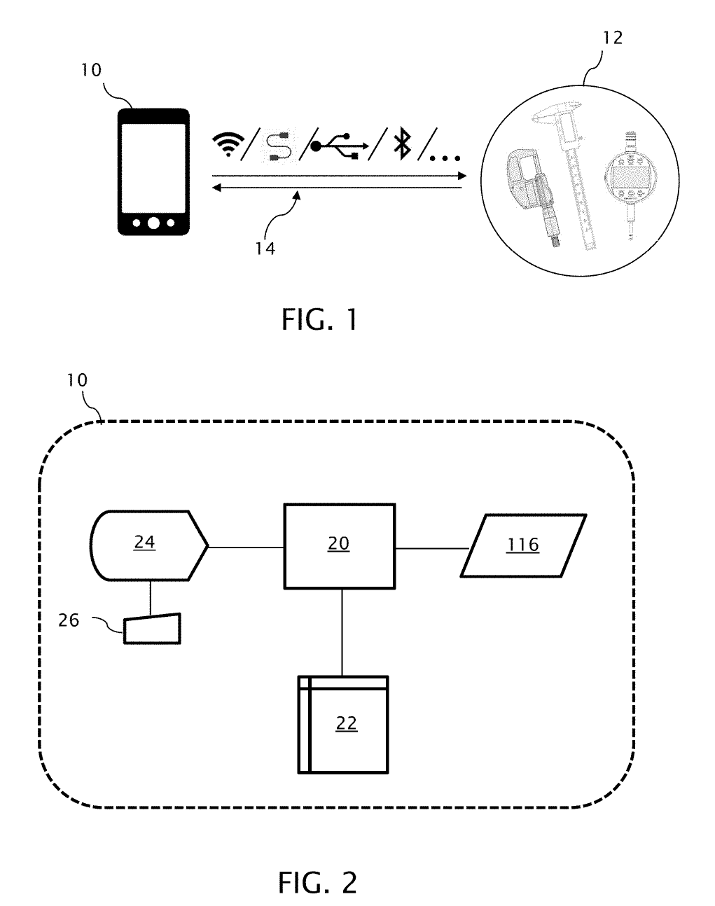

FIG. 1 depicts a mobile display device 10, such as a digital smart phone, in communication with one or more of a number of possible digital gauges 12, such as the depicted micrometer, caliper, and displacement gauge. The gauge probes can take a variety of forms including touch probes and optical probes. The mobile display device 10 and the digital gauges 12 include compatible communication modes 14 including the depicted Wi-Fi, cable, USB, and Bluetooth modes.

As shown in FIG. 2, the mobile display device 10 includes a central processor 20, which includes related servers and is connected to the communication port 16 as well as to an internal memory 22 and a display 24, including a user interface 26. The processor 20 accesses both a CAD (computer-aided design) model of a test part and a measurement plan for the test part stored in the memory 22 of the mobile display device 10.

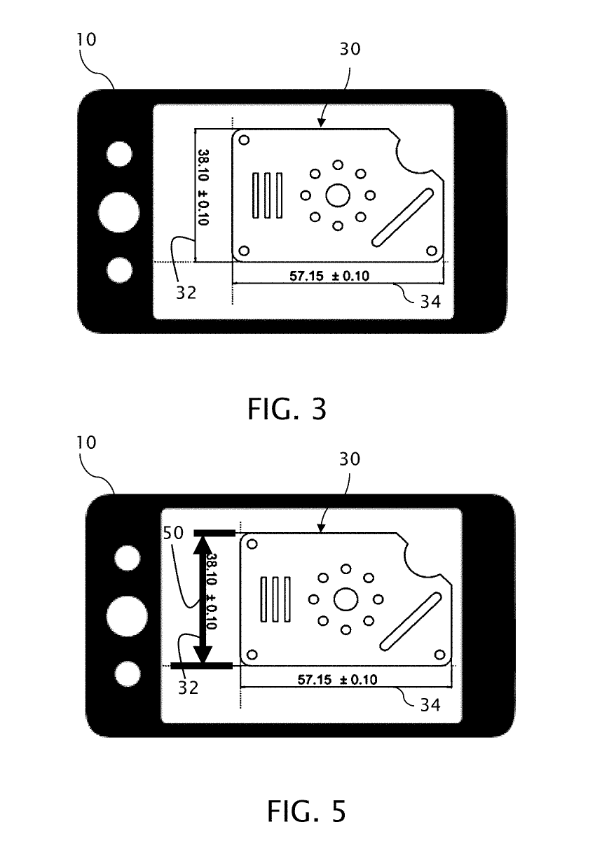

As shown in FIG. 3, the processor 20 displays the CAD model 30 of the test part together with dimensions 32 and 34 of the test part intended for measurement. The dimensions 32 and 34 along with their displayed nominal size and tolerance are drawn from the CAD Model. The processor 20 executes the measurement plan as a part of a computer program.

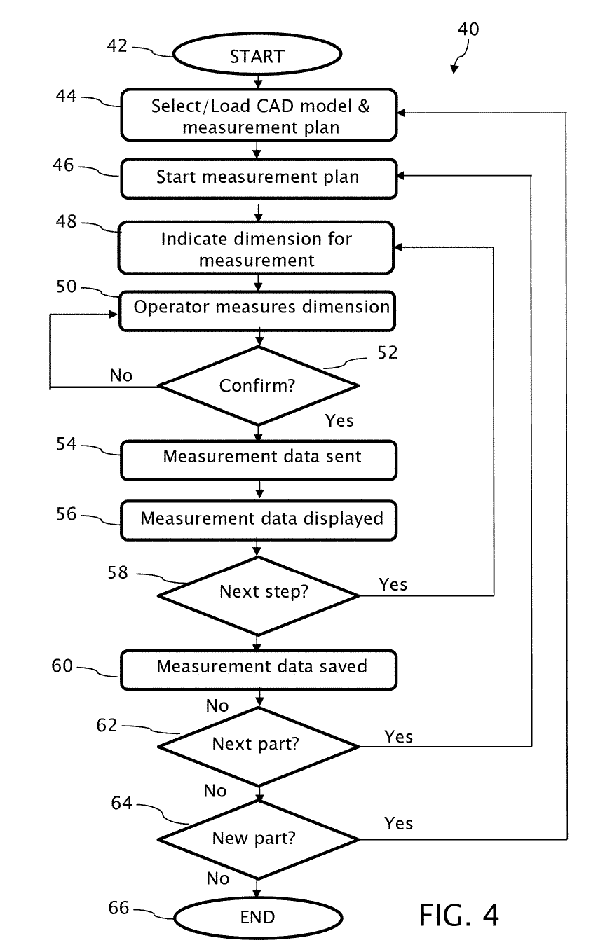

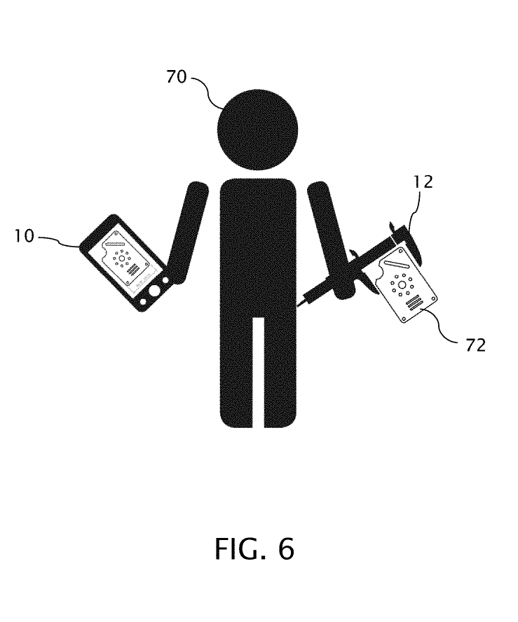

A flow chart 40 for the program as shown in FIG. 4 is initiated by a step 42 of starting the mobile display device 10 and digital gauge 12 to establish a communications link between the devices. A selectable CAD model of a test part and a measurement plan for measuring the test part are loaded at step 44 from the memory 22. Once loaded, the CAD model 30 along with the dimensions 30 and 32 intended for measurement are displayed on the display 24 of the mobile display device 10. The measurement plan, which schedules a succession of intended measurements of the test part, is launched at step 46, whereby in the next step 48, a first of the dimensions (e.g., 32) intended for measurement is highlighted on the display 24. The highlighting, such as shown in FIG. 5 as highlighted lines 50 of added weight, serves to direct an operator 70, such as shown in FIG. 6, to take a particular measurement of a test part 72 associated with the highlighted dimension (e.g., 32). The highlighting can be effected by changing the color, intensity (including blinking), or displayed representation (e.g., different line type or weight) of the dimension lines (e.g., 32) themselves or by making relative changes to the local backgrounds of the dimension lines (e.g., 32), such as by changing the background color or intensity. Other such examples include introducing shadowing, 3D perspective rotations, or other transformations.

At step 50, the operator 70 performs the indicated measurement of the test part 72 with the digital gauge 12 and the program awaits the results. During this pause, a choice is presented to the operator at decision step 52. If the operator is not satisfied that the intended measurement has been satisfactorily performed, program control returns to step 50 whereby the operator can repeat the intended measurement. If the operator 70 confirms at decision step 52 that the intended measurement has been satisfactorily performed, program control advances to step 54 whereby the acquired measurement data is transmitted from the digital gauge 12 to the mobile display device 10. The measurement data is received through the communications port 16 and registered as measurement data associated with the highlighted dimension (e.g., 32). The processor 20 at succeeding step 56 displays the acquired measurement data on the display 24 in association with the highlighted dimension (e.g. 32). Once the indicated measurement is taken and its associated measurement data is acquired by the mobile display device 10, the highlighting can be removed or changed to indicate a completed measurement.

As a part of a first measurement loop, decision step 58 poles whether another measurement of the test part 72 is scheduled by the measurement plan. If another measurement is scheduled, program control returns to step 48, whereby a second of the dimensions (e.g., 34) intended for measurement is similarly highlighted on the display 24. Control proceeds through the steps 50, 52, 54, and 56 for acquiring and displaying measurement data associated with the second dimension (e.g., 34). Via the first measurement loop, the remaining measurements of the test part 72 scheduled by the selected measurement plan can be similarly completed. Once the scheduled measurements have been completed, the decision step 58 directs program control to step 60 at which the acquired measurement data associated with each of the measured dimensions of the test part 72 is saved to the memory 22 or to an external data store. In addition, all of the acquired measurement data can be displayed on the display 24 of the mobile display device 10 in a form of convenience to the operator 60. For example, the measurement data can be displayed together with the appropriate CAD model in association with the dimension lines linked to the measurement data. Alternatively, the acquired measurement data from each of the scheduled measurements can be individually saved at step 56, and the collective measurement results from all of the scheduled measurements can be displayed or otherwise recorded or further processed such for determining whether the test part is to be accepted or rejected. For example, the acquired measurement data can be compared to the tolerances established by the CAD model either individually or collectively to determine if the measured test part 72 meets intended specifications. The results of this analysis can also be displayed on the display 24, recorded in the memory 22 or in an external data store in association with the measured test part 72, or printed in the form of a report through communication with a peripheral printer.

As a part of a second measuring loop, succeeding decision step 62 poles whether another test part represented by the selected CAD model is to be measured. This poll can be directed to the operator, and if the operator answers in the affirmative, program control returns to step 46 at which the previously selected measurement plan for measuring the test part is re-launched. Program control within the second measurement loop proceeds through steps 48, 50, 52, 54, 56, 58, and 60 as described above before returning to decision step 62, where the pole is repeated as to whether another test part represented by the selected CAD model is to be measured. If no more test parts represented by the selected CAD model are intended to be measured, program control proceeds to decision step 64 as a part of a third measuring loop.

Decision step 64 polls whether another test part represented by a different CAD model is intended to be measured. This poll can also be directed to the operator, and if the operator answers in the affirmative, program control returns to step 44 at which the operator can select and load from the memory 22 a different CAD model along with a different measurement plan. The new measurement plan is launched at step 46 and program control proceeds through steps 48, 50, 52, 54, 56, 58, 60, and 62 as described above before returning to decision step 64, where the pole is repeated as to whether another test part represented by a different CAD model is intended to be measured. If no more test parts are intended to be measured, control proceeds to step 66 at which one or both of the mobile display device 10 and the digital gauge 12 are turned off or the communications link between them is otherwise disconnected.

The flow chart 40 can be modified or expanded to support other functions, particularly for the convenience of the operator 70 and the efficacy of the results. For example, between decision steps 58 and 62, another decision step can be added to enable the operator 70 to redo a previous measurement. The scheduled measurement step intended to be repeated is identified by the operator 70, and the measurement steps 48, 50, 52, 54, and 56 are performed for the measurement step independently of the scheduled sequence of measurements set by the measurement plan before proceeding through step 60 at which the collective measurements of the test part are displayed and recorded. The measurement data processed at step 60 for recording can be stored in the memory 22, transferred to an external data store, or printed in a report via a peripheral printer. Additional processing can be performed not only on the measurement data associated with individual test parts but on comparative measurement data between the test parts, particularly for a set of test parts represented by the same CAD model.

1. A mobile CAD navigated measurement device for coordinating the measurement of a plurality of dimensions of a test part with a digital gauge comprising:
a mobile display device including a processor, a memory, a communication port, and a display;
the mobile display device being arranged for communication with the digital gauge through the communications port;
the processor being arranged for accessing a CAD model of the test part stored in the memory and for displaying a graphical image of the CAD model on the display;
the processor being further arranged for accessing a measurement plan stored in the memory that includes a schedule of a succession of intended measurements of the test part and for sequentially indicating different dimensions of the CAD model as being active on the display in accordance with the measurement plan;
the communication port being arranged to separately receive measurement data of the test part from the digital gauge in response to each of the dimensions of the CAD model being sequentially indicated as active on the display; and
the processor being yet further arranged to display the separately received measurement data of the test part from the digital gauge in association with the respective dimensions of the CAD model that are sequentially indicated as being active on the display and to record the separately received measurement data of the test part as measurements of corresponding dimensions of the test part.

2. The mobile CAD navigated measurement device of claim 1 in which the processor displays the respective dimensions of the CAD model that are sequentially indicated as being active on the display as highlighted dimension lines.

3. The mobile CAD navigated measurement device of claim 2 in which the highlighted dimension lines are distinguished by a change in a least one of color, intensity, and displayed representation of at least one of the dimension lines and the local backgrounds of the dimension lines.

4. The mobile CAD navigated measurement device of claim 1 in which the processor is further arranged to compare the measurements of corresponding dimensions of the test part to tolerances within the CAD model for accepting or rejecting the test part.

5. The mobile CAD navigated measurement device of claim 1 in which a plurality of CAD models and measurement plans are stored in the memory.

6. A method of coordinating the measurement of a plurality of dimensions of a test part with a digital gauge comprising steps of:
arranging a mobile display device to be in communication with the digital gauge through the communications port of the mobile display device;
accessing both a CAD model of the test part and a measurement plan for the test part stored in a memory of the mobile display device;
displaying a graphical image of the CAD model on a display of the mobile display device;
indicating a first dimension of the displayed CAD model as being active on the display in accordance with the measurement plan, which is arranged to schedule a succession of intended measurements of the test part;
receiving first measurement data of the test part from the digital gauge through the communication port;
displaying the first measurement data of the test part received from the digital gauge in association with the first dimension of the displayed CAD model that was indicated as being active on the display;
accessing the measurement plan to determine if another measurement of the test part is scheduled;
indicating a second dimension of the displayed CAD model as being active on the display in accordance with a second measurement of the test part being scheduled by the measurement plan;
receiving second measurement data of the test part from the digital gauge through the communication port;
displaying the second measurement data of the test part received from the digital gauge in association with the second dimension of the displayed CAD model that was indicated as being active on the display; and
recording the first and second measurement data of the test part as measurements of corresponding first and second dimensions of the test part.

7. The method of claim 6 including steps of selecting the CAD model of the test part and the measurement plan from a plurality of CAD models and measurement plans stored in memory and launching the measurement plan to collect at least the first and second measurement data associated a succession of intended measurements of the test part.

8. The method of claim 7 including a step of relaunching the measurement plan for measuring another test part that is represented by the selected CAD model.

9. The method of claim 7 including steps of selecting a different CAD model representing a different test part together with a different measurement plan and relaunching the measurement plan for measuring the different test part that is represented by the different CAD model.

10. The method of claim 6 in which the steps indicating the first and second dimensions include highlighting dimension lines representing the first and second dimensions.

11. The method of claim 10 in which the highlighted dimension lines are distinguished by a change in a least one of color, intensity, and displayed representation of at least one of the dimension lines and the local background of the dimension lines.

12. The method of claim 6 including a step of comparing the first and second measurement data to tolerances established by the CAD model to determine if the test part meets intended specifications.
